(19) United States
(12) Patent Application Publication
(10) Pub. No.: US 2002/0083194 A1
(43) Pub. Date: Jun. 27, 2002

(54) Routing method for traffic load distribution in packet-switched network

(76) Inventors: Sang Man Bak, Daejeon-shi (KR); Ki Jin Baek, Daejeon-shi (KR); Chung I1 Kim, Daejeon-shi (KR)

Correspondence Address: MERCHANT & GOULD P.C., P.O. Box 2903, Minneapolis, MN, 55402-0903, US

(21) Appl. No.: 09/738,643

(22) Filed: Dec. 15, 2000

(30) Foreign Application Priority Data
Nov. 4, 2000 (KR) 2000-65338

(51) Int. Cl. G06F 15/173

(52) U.S. Cl. 709/238; 709/241

(57) ABSTRACT

The present invention relates to a routing method for a traffic load distribution in a packet-switched network., which method includes a first step for computing an average cost between the start node and a plurality of nodes stored in a routing table and selecting a node having a cost lower than an average cost value K as a candidate of an intermediate node; a second step for randomly selecting one among the intermediate node candidates when a packet to be transmitted from the start node is generated and determining the selected node as an intermediate node of the packet; a third step for storing an information with respect to a path setting bit(b) a destination node address and intermediate node address in a header region of the packet and transmitting the packet to the intermediate node through the path of the lowest cost using the information stored in the routing table; and a fourth step for transmitting the packet to the destination node through the lowest cost path using the information stored in the routing table when the packet arrives at the intermediate node, for thereby diversifying data transmission path using an intermediate node address by providing an intermediate node address to a packet separately from a destination node address for thereby effectively distributing data traffic in a packet-switched network.

### BACKGROUND OF THE INVENTION

1. Field of the Invention

The present invention relates to a routing method for a traffic load distribution in a packet-switched network, and in particular to a routing method for a traffic load distribution in a packet-switched network which is capable of implementing an effective traffic load distribution in a packet-switched network in which a data transmission path is diversified by providing an intermediate node and a destination node to a transmitting packet.

2. Description of the Background Art

A routing protocol is used in an internet environment for communicating data between nodes, so that the information of an information provider can be shared.

In the above-described routing method, an effective path is searched for between the nodes on the Internet and is kept. In the case that a data packet is transmitted from a start node to a destination node, the data packet is transmitted through a path which has been preset between the start node and the destination node.

The packet transmitted from the start node is received to the destination node through multiple intermediate nodes. The router corresponding to each node includes a routing table which stores information with respect to the next node used for the shortest path in the direction of the destination node. When the packet is transmitted, each router transmits the packet to the next node corresponding to the shortest path in the direction of the destination node based on the information stored in the routing table.

The packet is formed of a binary digit which represents a header including user data, communication date, namely, identification number, start node address and destination node address, and error control data. The international standard concerning the packet exchange is disclosed in the IETF(Internet Engineering Task Force recommendation RFC(Request for Comments)-791.

When the packet is received, the router corresponding to each node performs a routing operation for transferring the packet to the destination node using a communication data contained in the packet.

As the internet is widely used, the amount of the traffic data is significantly increased. Therefore, quicker and more effective packet transmission is required.

In the routing protocol(OSPF, RIP) used in the internet, when a packet is received, the packet is transmitted to the next node which has been preset by adapting the destination node in the routing table. Information with respect to the distance between the current node and each node which forms a packet-switched network is included in the routing table. Therefore, the data concerning the shortest path to the destination node through a certain node is included in the table. In this case, it is possible to obtain an information with respect to the next node by adapting the shortest path.

Therefore, in the method for proceeding to the next node using the routing table, due to the fixed data of the routing table is fixed, when the packets having the same start node and destination node are concentrated, the data process gets delayed because the packets are transmitted through the same data transmission path or a data bottle neck phenomenon occurs between the nodes.

In particular, the bottle neck phenomenon may become a serious problem in the internet in which the traffic is sharply increased. The above-described data bottle neck phenomenon increases traffic congestion, packet loss ratio, and average transmission delay time and decreases data transmission capacity and further internet performance.

### SUMMARY OF THE INVENTION

Accordingly, it is an object of the present invention to provide a routing method for a traffic load distribution in a packet-switched network which is capable of diversifying a data transmission path using an intermediate node address by providing an intermediate node address to a packet separately from a destination node address for thereby effectively distributing data traffic in a packet-switched network.

To achieve the above objects, there is provided a routing method for a traffic load distribution in a packet-switched network in a routing method in which a certain packet is transmitted from a start node to a destination node through the shortest or the most cost-effective path based on the information stored in a routing table in a packet-switched network formed of a plurality of nodes, which includes a first step for computing an average cost between the start node and a plurality of nodes stored in a routing table and selecting a node having a cost lower than an average cost value K as a candidate of an intermediate node, a second step for randomly selecting one among the intermediate node candidates when a packet which will be transmitted from the start node is generated and determining the selected node as an intermediate node of the packet, a third step for storing information with respect to a path setting bit(b) a destination node address and an intermediate node address in a header region of the packet and transmitting the packet to the intermediate node through the path of the lowest cost using the information stored in the routing table, and a fourth step for transmitting the packet to the destination node through the lowest cost path using the information stored in the routing table when the packet arrives at the intermediate node.

### BRIEF DESCRIPTION OF THE DRAWINGS

The present invention will become better understood with reference to the accompanying drawings which are given only by way of illustration and thus are not limitative of the present invention, wherein;

FIG. 1 is a block diagram illustrating an apparatus adapted to a routing method for a traffic load distribution in a packet-switched network according to the present invention;

FIG. 2 is a view illustrating the construction of a network of a data transmission path of a packet-switched network according to the present invention; and

FIG. 3 is a flow chart of a routing method for a traffic load distribution in a packet-switched network according to the present invention.

### DETAILED DESCRIPTION OF THE PREFERRED EMBODIMENTS

The embodiments of the present invention will be explained with reference to the accompanying drawings.

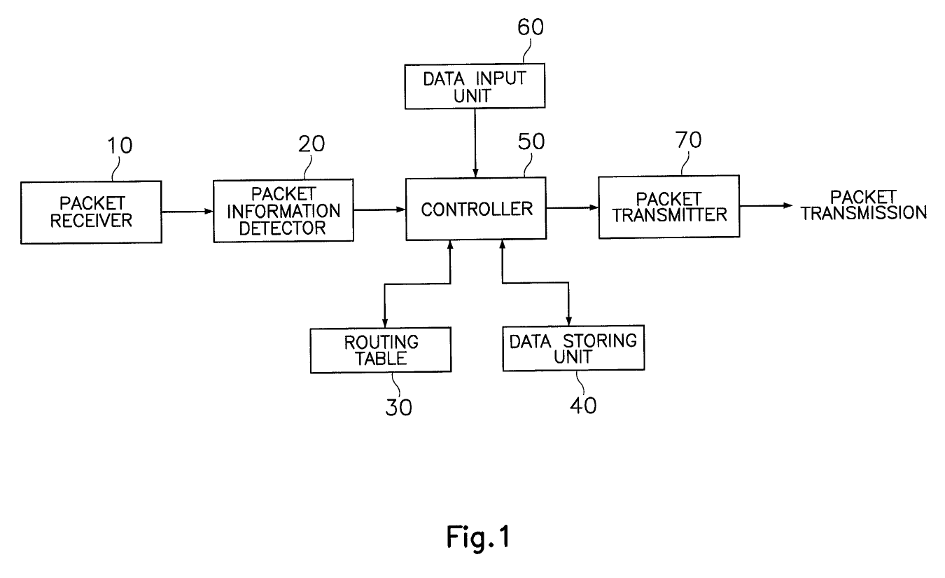

FIG. 1 is a view illustrating an apparatus adapted in a routing method for a traffic load distribution in a packet-switched network according to the present invention.

Hereinafter, the distance between nodes according to the invention is to be understood based on the concept of cost-effective path.

Reference numeral 10 represents a packet receiver for receiving a packet transmitted from other nodes. Reference numeral 20 represents a packet information detector for analyzing a packet received through the packet receiver 10 and detecting data for a communication. In the present invention, the packet information detector 20 detects a destination node address, an intermediate node address, and data of a path determination bit(hereinafter called b-bit) which is an identifier which indicates a destination state.

Reference numeral 30 represents a routing table which stores distance (cost) information with respect to each node and information with respect to the next node corresponding to the shortest (lowest cost) path to a certain destination node, and reference numeral 40 represents data storing unit for storing an information with respect to the intermediate node determined by a variable K computed based on the information stored in the routing table 30.

Reference numeral 50 represents a controller by which a packet is received based on a destination node address and an intermediate node address, a b-bit data detected by the packet information detector 20 is transmitted through the shortest (lowest cost) path through the intermediate node, and when a new packet occurs based on the current node as a start node, the intermediate node is provided to the packet, and the packet having an address with respect to the intermediate node is transmitted to the intermediate node.

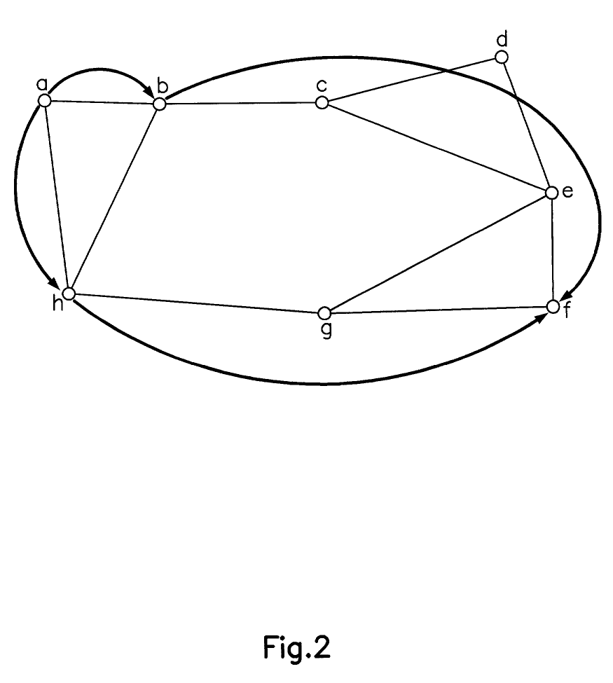

In the state that a packet-switched network is formed of the nodes a, b, c, d, e, f, and g as shown in FIG. 2, an apparatus(router) which implements a routing method for traffic load distribution in a packet-switched network according to the present invention is installed at each node. The data stored in the routing table of the apparatus at the node “a” is shown in Table 1. The data stored in the routing table of the apparatus of the node “h” is shown in Table 2.

TABLE 1
Routing table of node “a”

| Nodes | Distance(D) | Next nodes |
|---|---|---|
| A | 0 | — |
| B | 1 | B |
| C | 2 | B |
| D | 3 | B |
| B | 3 | B |
| F | 3 | H |
| G | 2 | H |
| H | 1 | H |

TABLE 2
Routing table of node “h”

| Nodes | Distance(D) | Next nodes |
|---|---|---|
| A | 1 | A |
| B | 1 | B |
| C | 2 | B |
| D | 3 | B |
| E | 2 | G |
| F | 2 | G |
| G | 1 | G |
| H | 0 | — |

Table 1 will now be explained. Namely, the distance between a reference node “a” and the node and the data with respect to the next node corresponding to the shortest distance which is routed when transmitting data to the destination node are shown in the table.

As shown in FIG. 1, reference numeral 60 represents a data input unit for inputting data having a certain destination node “f” in a state that the current node is defined as a start node. Reference numeral 70 represents a packet transmitter for generating a packet of the header with respect to a b-bit data, a start node address, a destination node address and an intermediate node address in accordance with a control of the controller 50 and transmitting the generated packet to the next node.

Here, the b-bit data uses a 1-bit which is not used in the header of the conventional packet. The first bit is set as a b-bit data region based on the state that the first bit of the flag field of the header of the conventional packet is blank. The intermediate node address is formed of a 32-bit which is the same as the start node address and destination node address. The location of the subject node is in the next field of the destination node address field.

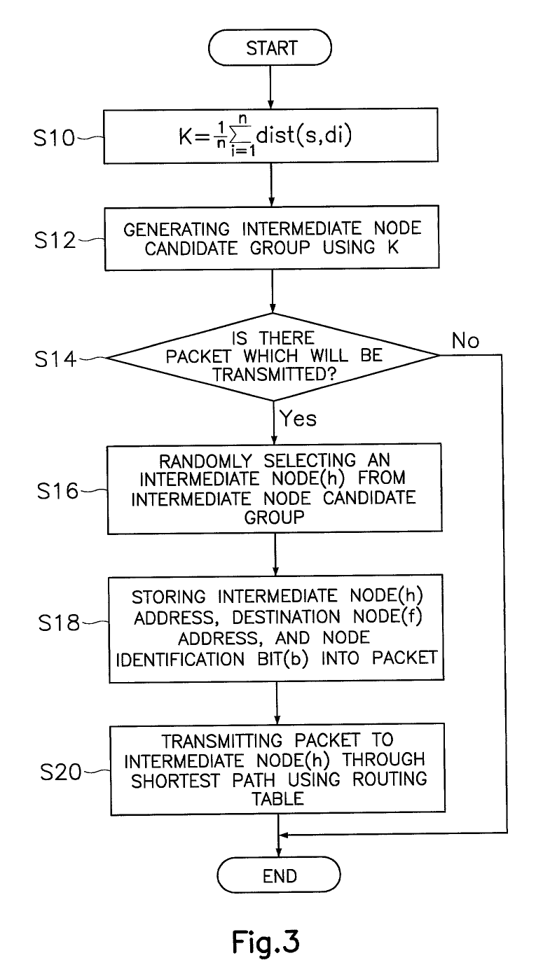

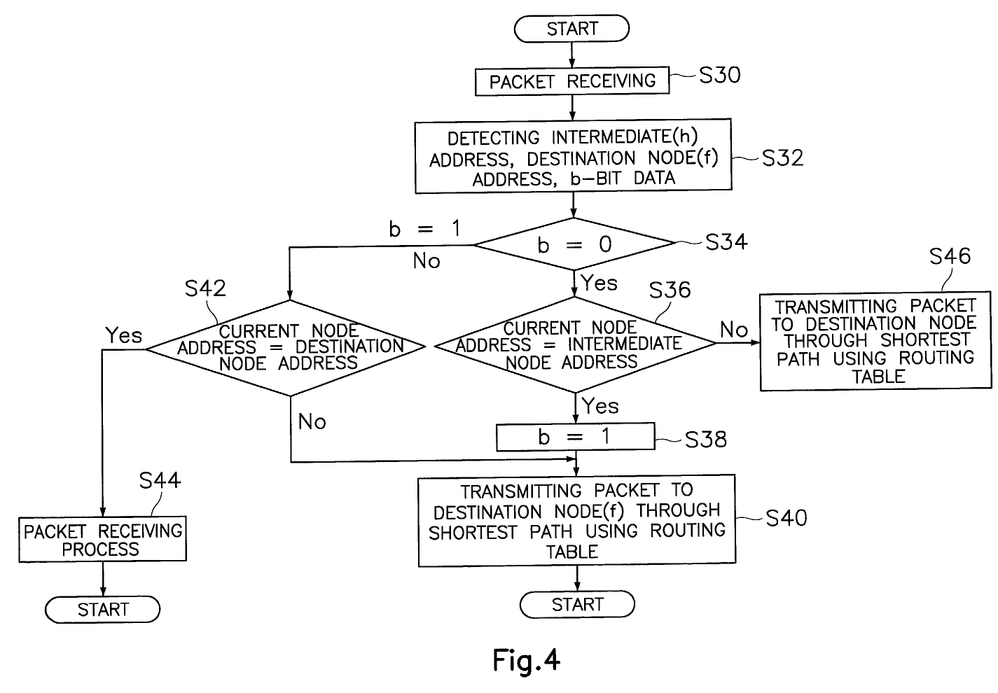

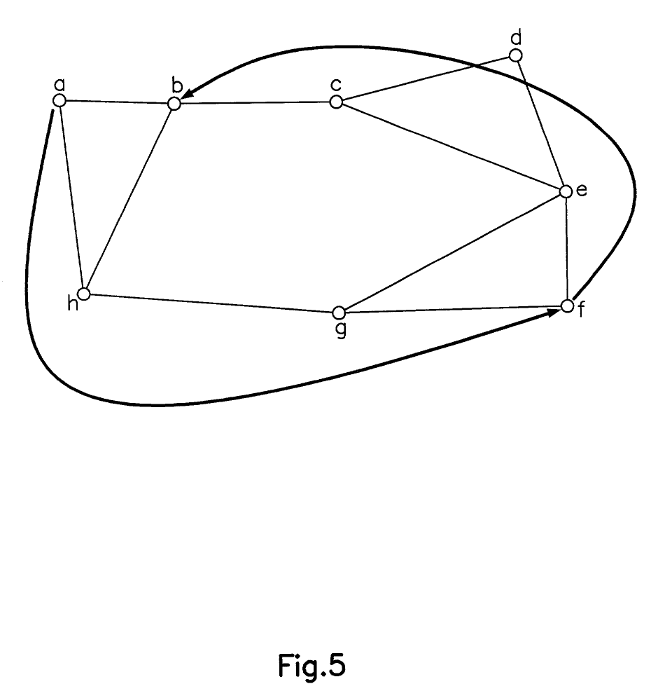

The routing method for a traffic load distribution in a packet-switched network according to the present invention will be explained with reference to FIGS. 3 and 4.

As shown in FIG. 3, the controller 50 computes a variable K with respect to the average distance with respect to each node based on the information stored in the routing table 30(S10).

The equation for obtaining the variable K is as follows.

$$K = \frac{1}{n} {\sum }_{i = 1}^{n} dist ( s , {d}_{i} ) \qquad Equation 1$$

Here, “n” represents the number of nodes, and dist(s, di) represents the distance between the current node and each node.

As shown in Table 1, the value K=(0+1+2+3+3+3+2+1)/8=1.875 at the node “a”.

The controller 50 having the value K obtained from Step S10 generates a node in which the value of distance stored in the routing table of the node “a” is smaller than that of K, namely, {a, b, h} as an intermediate node candidate group for the reason that if all nodes are set to the intermediate nodes, as shown in FIG. 5, even when the distance between the start node and the destination node is 1, the intermediate node is set to the nodes “f”, the data transmission path is formed from the node “a” to the node “f”, and the data is transmitted to the node “b”. In this case, the path makes a long detour.

Therefore, in order to prevent the above problems, the each node having a distance smaller than the value K is generated as part of an intermediate node candidate group.

If the controller 50 is grouped in the construction of the node “h”, the value K computed in the step S10 is (1+1+2+3+2+2+1+0)/8=1.5 and becomes an intermediate node candidate group generated in Step S12.

Namely, the controller 50 computes the value K with respect to each node using the data stored in the routing table. The value K is compared with the distance “d” between the nodes stored in the routing table, and the nodes having a distance(K>d) smaller than the value K are generated as the intermediate node candidate group.

The controller 50 determines whether, when a new data to be transmitted is inputted from the data input unit 60, there is a packet to be transmitted(S14). When a certain data is inputted from the data input unit 60, and a packet to be transmitted occurs(Yes in Step 14), a node is randomly selected from the intermediate node candidate group stored in the data storing unit 40(for example the node “h”), and the selected node is set as the intermediate node(S16).

The controller 50 packet-processes the data inputted from the data input unit 60 and records the b-bit data at the header portion of the packet as “0” and stores the addresses of the destination node “f” and the intermediate node “h” and obtains an information corresponding to the next node “h” by adapting the intermediate node “h” to the routing table 30 and transmits a corresponding packet to the node “h”.

The routing operation of the node which receives a packet having a header will be explained with reference to the flow chart of FIG. 4.

When a certain packet is received through the packet receiver 10, the packet information detector 20 detects a b-bit data, an address of a destination node “f” and an address of an intermediate node “h” included in the packet and applies the detected data to the controller 50.

The controller 50 determines whether the b-bit data is “0” (S34). If the b-bit data is “0”, it is decided whether a corresponding packet is not passed through the intermediate node, and it is judged whether the address of the current node and the address of the intermediate packet is matched(S36).

For example, if the current node is the node “h”, as a result of the step S36, since the address of the current node and the address of the intermediate node “h” are matched, it is recognized that the current node corresponds to the intermediate node. Therefore, the b-bit data in the header of the packet is recorded as “1” in the packet transmitter 70(S38), and the packet is transmitted to the node “g” corresponding to the next node in the case that the destination node is “f” based on the data in the routing table 30(S40).

As a result of the decision of the step S34, if the b-bit data is “1”, it is determined that a corresponding packet is passed through the intermediate node, and it is determined whether the address of the current node and the address of the destination are matched(S42).

As a result of the judgment, if the address of the current node and the address of the destination node “f” are matched(Yes) in a state that the current node is “f”, the controller 50 receives and processes a corresponding packet(S44). In a state that the current node is not “f”, if the address of the current node and the address of the destination node “f” are not matched(No), the routine is moved to the step S40. In the case that the destination node is “f”, the packet is transmitted to the node “g” corresponding to the shortest path based on the data stored in the routing table 30.

In the step S36, in a state that the address of the current node is not “h”, if the address of the current node and the address of the intermediate node are not matched(No), the controller 30 transmits the packet to the intermediate node through the shortest path using the routing table 30.

As shown in FIG. 2, the intermediate node is set to “h” with respect to the packet in which the start node is “a” and the destination node is “f”, the packet is transmitted in a sequence of the node “a”→ the node “h”→ the node “g”→ the node “f”, and when the intermediate node is set to “b”, the packet is transmitted in a sequence of the node “a”→ the node “b”→ the node “c”→ the node “e”→ the node “f”.

Therefore, it is possible to provide completely different paths with respect to the packet having the same start node address and destination node.

As described above, when transmitting the packet, an intermediate node is further provided in addition to the start node and the destination node, so that the packet is transmitted to the destination node through the intermediate node. In addition, a plurality of data transmission paths are formed by variably adapting the intermediate node.

Therefore, in the present invention, it is possible to prevent a bottle neck phenomenon which may occur because the packet having the same stat node and destination node is transmitted through the same data transmission path, so that an average data transmission speed is increased, and the transmission capacity of the data is enhanced by decreasing the average transmission delay time, and it is possible to increase a reliability of the data transmission.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. A routing method for a traffic load distribution in a packet-switched network in which a certain packet is transmitted from a start node to a destination node through a shortest path based on an information stored in a routing table in a packet-switched network formed of a plurality of nodes, comprising:
a first step for computing an average cost between the start node and a plurality of nodes stored in a routing table and selecting a node having a cost lower than an average cost value K as a candidate of an intermediate node;
a second step for randomly selecting one among the intermediate node candidates when a packet to be transmitted from the start node is generated and determining the selected node as an intermediate node of the packet;
a third step for storing information with respect to a path setting bit(b) a destination node address and an intermediate node address in a header region of the is packet and transmitting the packet to the intermediate node through the path of the lowest cost using an information stored in the routing table; and
a fourth step for transmitting the packet to the destination node through the lowest cost path using the information stored in the routing table when the packet arrives at the intermediate node.

2. The method in accordance with claim 1, wherein a path setting bit(b) of the packet transmitted in the third step is set to “0”.

3. The method in accordance with claim 1, wherein a path setting bit(b) of the packet transmitted in the fourth step is set to “1”.

4. The method in accordance with claim 1, wherein said first step for computing an average cost includes:
a step for counting the number of nodes in a path from a start node to a destination node;
a step for computing a cost from the start node with respect to each node in the path and summing each cost; and
a step for computing an average cost by dividing the cost summed in the summing step with the number of the nodes counted in the counting step.

5. A routing method for a traffic load distribution in a packet-switched network in which a certain packet is transmitted from a start node to a destination node through a shortest path based on an information stored in a routing table in a packet-switched network formed of a plurality of nodes, comprising:
a first step for computing an average distance between the start node and a plurality of nodes stored in a routing table and selecting a node having a distance shorter than an average distance value K as a candidate of an intermediate node;
a second step for randomly selecting one among the intermediate node candidates when a packet to be transmitted from the start node is generated and determining the selected node as an intermediate node of the packet;
a third step for storing information with respect to a path setting bit(b) a destination node address and an intermediate node address in a header region of the packet and transmitting the packet to the intermediate node through the path of the shortest distance using an information stored in the routing table; and
a fourth step for transmitting the packet to the destination node through the shortest distance path using the information stored in the routing table when the packet arrives at the intermediate node.
